(19) United States
(12) Patent Application Publication
(10) Pub. No.: US 2005/0192679 A1
(43) Pub. Date: Sep. 1, 2005

(54) Graphical representation of web site interaction

(76) Inventor: Paul G. Strupp, Boulder, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/645,395

(22) Filed: Aug. 21, 2003

(51) Int. Cl. G05B 13/02; G06F 19/00; G06F 15/18

(52) U.S. Cl. 700/28; 700/36; 700/103; 700/30; 700/31; 700/49; 706/10; 706/14

(57) ABSTRACT

Disclosed are novel methods and apparatus for provision of efficient, effective, and/or flexible graphical representation of web site interaction. In an embodiment of the present invention, a method of generating a graphical representation of interaction between a plurality of reservoirs is disclosed. The method includes determining a number of referrals to each of the plurality of reservoirs from the remaining plurality of reservoirs; determining a total traffic handled by each of the plurality of reservoirs; determining reservoir types and representing each of the plurality of the reservoirs accordingly; determining a relative size of each of plurality of reservoirs; connecting select reservoirs from the plurality of reservoirs; providing a plurality of net flow indicators between the select reservoirs; and providing a plurality of outflow indicators between the select reservoirs.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright © 2002, Sun Microsystems, Inc., All Rights Reserved.

### FIELD OF INVENTION

The present invention generally relates to the field of data handling. More specifically, an embodiment of the present invention provides for a graphical representation of web site interaction.

### BACKGROUND OF INVENTION

As the Internet becomes more commonplace in everyday life, the need for reliable services gains more importance. Server computers generally provide the information available on the Internet. For example, a client computer establishes a connection with a given server and requests the desired information or data, which the server then sends to the client computer over the Internet infrastructure that may be displayed on the client computer in the form of text, graphics, and other data.

Generally, an Internet server can only support a given load (i.e., number of connected users) depending on the types of services or data provided by the server, client configuration (e.g., connection speed), and the server configuration. Other factors to consider include how the server is connected to the Internet (e.g., the bandwidth of the connection between the server and the Internet infrastructure). Time critical tasks such as real-time phone or video calls require additional considerations to ensure that the server and the clients can communicate without unreasonable delay.

The task of designing servers to ensure acceptable response times can be a relatively difficult problem to address. Another more complicated issue arises when one tries to ensure that users find their desired information quickly. Moreover, one common use for Internet-based servers is to provide self-help information. Such use reduces the requirement for a company to hire many support personnel or offer extensive support hours, thereby reducing costs associated with support provision. Ensuring that users have ready access to appropriate help information is critical when designing web site to provide such information (e.g., technical and customer service support web sites). One goal in designing such web sites it to enable a user to quickly find the desired information. One indication of the effectiveness of a web site design is to try to form an understanding of how users move between different web sites. There are, however, many variables that need to be included in forming this understanding. And, for most people, the complex interaction of inter-website traffic can be too difficult to effectively grasp.

### SUMMARY OF INVENTION

The present invention, which may be implemented utilizing a general-purpose digital computer, in certain embodiments of the present invention, includes novel methods and apparatus to provide efficient, effective, and/or flexible graphical representation of web site interaction.

In one embodiment of the present invention, a graphical representation of interaction between reservoirs is disclosed. The graphical representation includes a plurality of reservoirs, each of the plurality reservoirs communicating with at least another one of the plurality of reservoirs; a plurality of connectors disposed between select reservoirs from the plurality of reservoirs to indicate communication between the select reservoirs of the plurality of reservoirs, each of the connectors having a prominence corresponding to a level of the communication between the select reservoirs; a plurality of net flow indicators to identify a net flow between the select reservoirs of the plurality of reservoirs; and a plurality of outflow indicators to indicate an amount of traffic between the select reservoirs of the plurality of reservoirs.

In a further embodiment of the present invention, a method of generating a graphical representation of interaction between a plurality of reservoirs is disclosed. The method includes determining a number of referrals to each of the plurality of reservoirs from the remaining plurality of reservoirs; determining a total traffic handled by each of the plurality of reservoirs; determining reservoir types and representing each of the plurality of the reservoirs accordingly; determining a relative size of each of plurality of reservoirs; connecting select reservoirs from the plurality of reservoirs; providing a plurality of net flow indicators between the select reservoirs; and providing a plurality of outflow indicators between the select reservoirs.

In yet another embodiment of the present invention, a method of generating a graphical representation of interaction between reservoirs is disclosed. The method includes providing a plurality of reservoirs, each of the plurality reservoirs communicating with at least another one of the plurality of reservoirs; providing a plurality of connectors disposed between select reservoirs from the plurality of reservoirs to indicate communication between the select reservoirs of the plurality of reservoirs, each of the connectors having a prominence corresponding to a level of the communication between the select reservoirs; providing a plurality of net flow indicators to identify a net flow between the select reservoirs of the plurality of reservoirs; and providing a plurality of outflow indicators to indicate an amount of traffic between the select reservoirs of the plurality of reservoirs.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which certain embodiments of the present invention may be implemented;

FIG. 2 illustrates an exemplary graphical representation 200 in accordance with an embodiment of the present invention;

FIG. 3A illustrates an exemplary flow diagram of a method 300 in accordance with an embodiment of the present invention; and

FIG. 3B illustrates an exemplary flow diagram of a method 350 which includes additional stages which may follow the method 300 of FIG. 3A in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

Also, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, hard disk, optical disks, CD-ROMs, and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data. Moreover, data discussed herein may be stored in a single database, multiple databases, or otherwise in select forms (such as in a table).

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

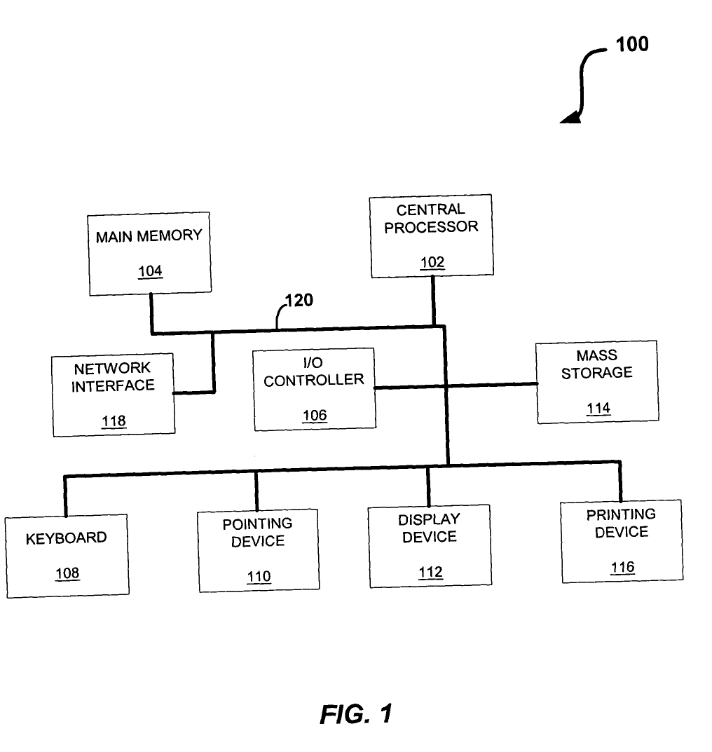

FIG. 1 illustrates an exemplary computer system 100 in which certain embodiments of the present invention may be implemented. The system 100 comprises a central processor 102, a main memory 104, an input/output (I/O) controller 106, a keyboard 108, a pointing device 110 (e.g., mouse, track ball, pen device, or the like), a display device 112, a mass storage 1 4 (e.g., a nonvolatile storage such as a hard disk, an optical drive, and the like), and a network interface 1 18. Additional input/output devices, such as a printing device 116, may be included in the system 100 as desired. As illustrated, the various components of the system 100 communicate through a system bus 120 or similar architecture.

In accordance with an embodiment of the present invention, the computer system 100 includes a Sun Microsystems computer utilizing a SPARC microprocessor available from several vendors (including Sun Microsystems, Inc., of Santa Clara, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a very long instruction word (VLIW) microprocessor, a processor implementing a combination of instruction sets, and the like.

The network interface 118 provides communication capability with other computer systems on a same local network, on a different network connected via modems and the like to the present network, or to other computers across the Internet. In various embodiments of the present invention, the network interface 118 can be implemented utilizing technologies including, but not limited to, Ethernet, Fast Ethernet, Gigabit Ethernet (such as that covered by the Institute of Electrical and Electronics Engineers (IEEE) 801.1 standard), wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, wireless networks (such as those implemented by utilizing the wireless application protocol (WAP)), time division multiplexing (TDM), universal serial bus (USB and its varieties such as USB II), asynchronous transfer mode (ATM), satellite, cable modem, and/or FireWire.

Moreover, the computer system 100 may utilize operating systems such as Solaris, Windows (and its varieties such as CE, NT, 2000, XP, ME, and the like), HP-UX, IBM-AIX, PALM, UNIX, Berkeley software distribution (BSD) UNIX, Linux, Apple UNIX (AUX), Macintosh operating system (Mac OS) (including Mac OS X), and the like. Also, it is envisioned that in certain embodiments of the present invention, the computer system 100 is a general purpose computer capable of running any number of applications such as those available from companies including Oracle, Siebel, Unisys, Microsoft, and the like.

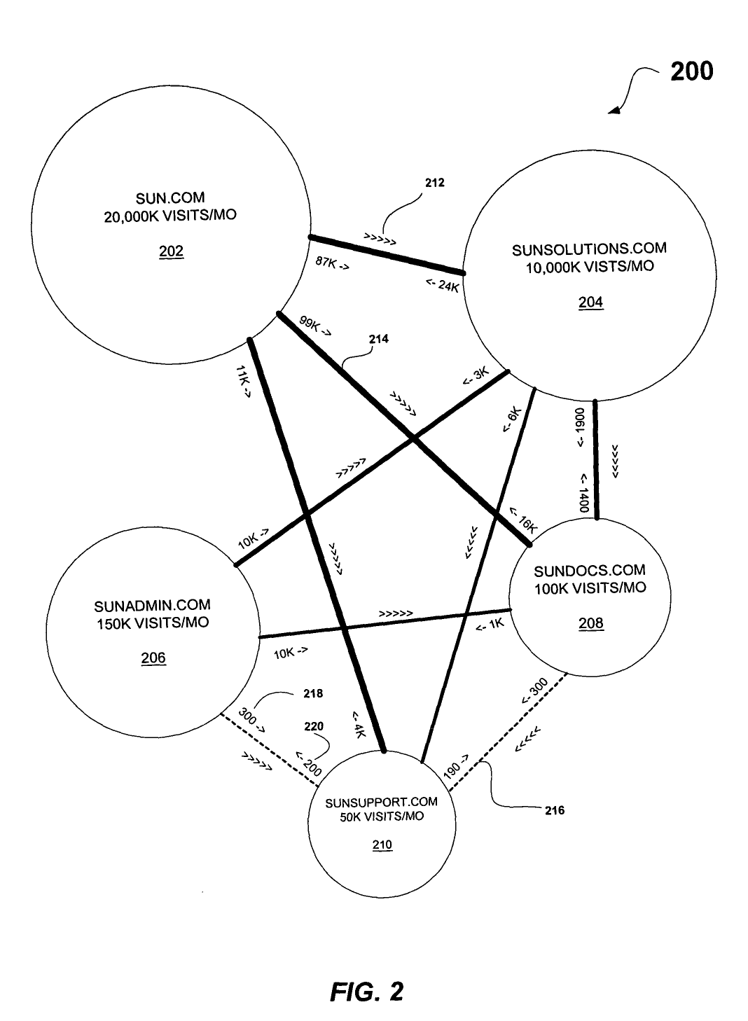

FIG. 2 illustrates an exemplary graphical representation 200 in accordance with an embodiment of the present invention. The graphical representation 200 visually illustrates the interaction of web traffic between sites (202, 204, 206, 208, and 210) in one embodiment of the present invention. As illustrated in FIG. 2, information inside each circle may indicate the total site traffic (e.g., 20,000K visitors per month for 202). The size or area of each circle may be proportional to the total web traffic to the site. It is envisioned that other shapes such as a square, rectangle, cloud, polygon, non-geometric shapes, their combinations, and the like may be utilized to implement various embodiments of the present invention.

In another embodiment of the present invention, each circle is colored or shaded to indicate whether that site is an importer (i.e., more data imported versus exported) or an exporter (i.e., more data exported than imported). For example, green may indicate importer sites and red may indicate exporter sites (e.g., 202 would be an exporter in red and so on).

The graphical representation 200 further includes a series of arrows to indicated net flow direction between the sites (e.g., 202, 204, 206, 208, and 210). For example, the arrows 212 indicate a net flow from site 202 to site 204. In one embodiment of the present invention, the arrows may be shaded or colored (e.g., green), for example, for easier identification. In a further embodiment of the present invention, the thickness of the connecting lines (e.g., 214 and 216) indicate the inter-site gross traffic. For example, a relatively thicker line (e.g., 214) indicates more traffic exchanged between sites (e.g., 202 and 208) than a dotted line (e.g., 216 between sites 208 and 210). It is also envisioned that other indicators, or combinations thereof, such as color, shapes, and the like may be utilized to indicate the relative prominence of a connection.

It is envisioned that a selected thickness may indicate a range of visitors per month in accordance with an embodiment of the present invention. For example, a half-inch thick line may indicate 10,000 to 100,000 visits per month versus a quarter-inch thick line indicating 1,000 to 10,000 visits per month. Similarly, a dotted line may indicate visits below a threshold value such as 1,000.

In another embodiment of the present invention, the graphical representation 200 further includes flow numbers and direction indicators to indicate how much traffic is flowing from each site to another (e.g., 218-220 indicating directional flow between sites 206 and 210). In a further embodiment of the present invention, the graphical representation 200 includes a legend to identify, for example, visit range for each line thickness, definition of arrows, information within each circle, colors or shades chosen for importer versus exporter sites, and the like.

In an embodiment of the present invention, the graphical representation 200 is envisioned to assist in one or more of the following tasks:
why users move between sites;
how isolated each site is;
whether users likely navigate between sites through external paths (e.g., by bookmarking);
users have learned where to go in spite of site design;
which site may be used as a portal site;
which site is used as a feature (rather than a portal);
how resources may be made painlessly available to users;

In an additional embodiment of the present invention, content usage (e.g., which part of each site is visited and how frequently) and/or exit content (e.g., which part of each site users exit from and how frequently) of each site may be further monitored to assist in achieving the above tasks.

In an alternate embodiment of the present invention, the techniques discussed herein are envisioned to assist in designing servers (e.g., web sites) to ensure acceptable response times. For example, the techniques discussed herein may assist in ensuring that users find their desired information more quickly (e.g., finding self-help information provided through technical and/or customer service support web sites). Additionally, the complex interaction of inter-website traffic can be ascertained and/or effectively grasped with the assistance of various embodiments of the present invention.

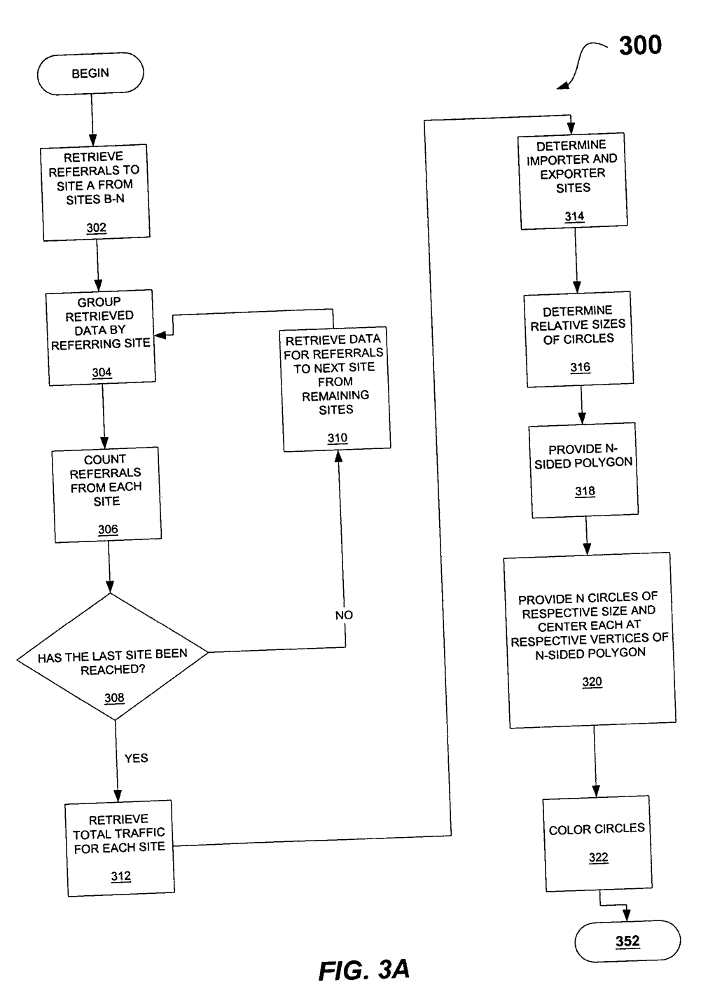

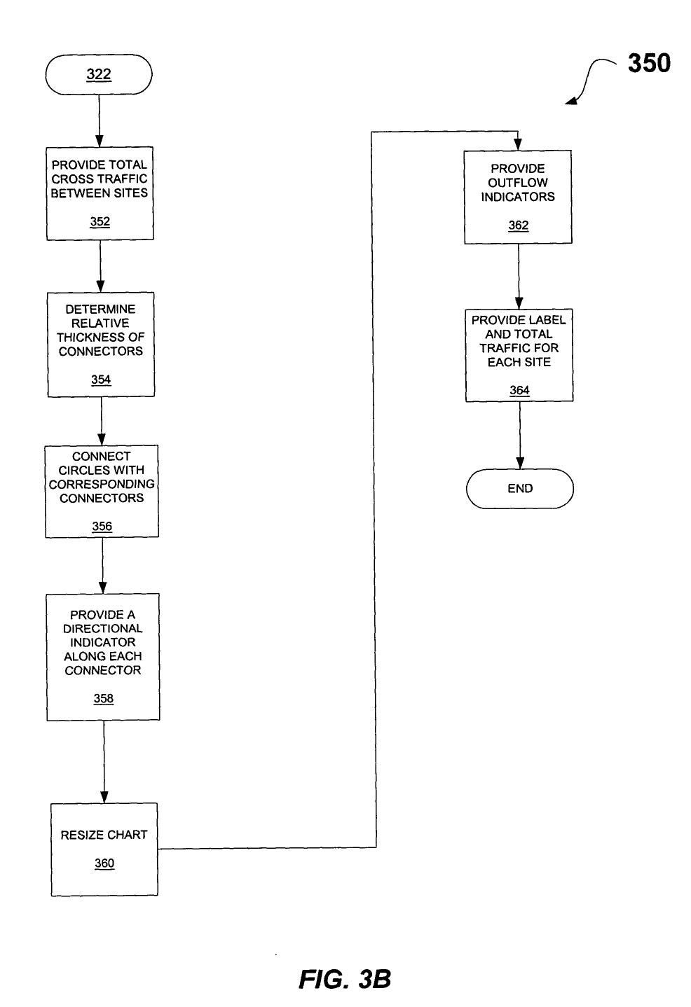

FIG. 3A illustrates an exemplary flow diagram of a method 300 in accordance with an embodiment of the present invention. In one embodiment of the present invention, the method 300 is utilized to generate a portion of the graphical representation 200 discussed with reference to FIG. 2. The method 300 begins with a stage 302 in which retrieves data regarding referrals to site A from sites B through N, where N can be any digit (i.e., referrals from any number of sites to A). In an embodiment of the present invention, the stage 302 is performed during a given timeframe and/or with optional filters applied. A filter is generally a tool to limit items based on a specific criterion or criteria. For example, a filter in a database query may be implemented by using a “where” clause. Filters may also include those that identify U.S. versus international traffic, new users, errors, and the like.

In a stage 304, the retrieved data is grouped or sorted by the referring site. A stage 306 counts the referrals from each site. In one embodiment of the present invention, the data discussed with respect to FIGS. 3A and 3B may be stored in a table or matrix. For example the rows may store destination site data whereas the columns may store referring site data. It is envisioned that the matrix representation may assist in performing the calculations and/or determinations discussed with respect to FIGS. 3A and 3B.

In a stage 308, it is determined whether the last site has been reached. If the stage 308 determines that there are still remaining sites to consider, a stage 310 retrieves data for referrals to the next site from the remaining sites (e.g., referrals to B from sites A and C through N). The method 300 then continues with the stage 304.

If the stage 308 determines that the last site has been reached, a stage 312 retrieves total traffic data for each site. In an embodiment of the present invention, the stage 312 is performed during a given timeframe and/or with optional filters, for example, as measured by specified units.

A stage 314 determines importer versus exporter sites. In one embodiment of the present invention, if the data is stored in a matrix, the following algorithm may be utilized:
if sum of Row A>sum of Column A, then site A=“importer”;
if sum of Row A<sum of Column A, then site A=“exporter”; and
if sum of row A=sum of Column A, then site A=“neutral”.

In a stage 316, the relative size of circles (e.g., representing each site) is determined. For example, the radius of each circle may be determined by applying the following:
Rn=\sqrt{Vn/Vs},
where Rn is the radius of circle N, Vn is the total traffic to Site N (e.g., from the stage 312), and Vs is the minimum value of Vn.

A stage 318 provides an N-sided polygon. In one embodiment of the present invention, the size of the polygon may be such that the length of each side is:
S=R1+Rm+X,
where R1 is the radius of largest circle, Rm is the radius of second largest circle, and X is an arbitrary additional spacing (e.g., for fitting the chart to a given page or display size).

In a stage 320, N circles are provided with respective sizes and each centered at vertices of the N-sided polygon. A stage 322 colors each circle for easier identification (e.g., based on information from the stage 314). For example, red may indicate an importer, green an exporter, and gray an exporter site. The method 300 continues with a stage 352 of FIG. 3B.

FIG. 3B illustrates an exemplary flow diagram of a method 350 which includes additional stages which may follow the method 300 of FIG. 3A in accordance with an embodiment of the present invention. In one embodiment of the present invention, the method 300 is utilized to generate a portion of the graphical representation 200 discussed with reference to FIG. 2. The method 350 continues the stage 322 of FIG. 3A with a stage 352 which provides the total cross traffic between the sites. The total cross traffic of the stage 352 may be determined as follows in accordance with an embodiment of the present invention:
Tx(ij)=Tij+Tji,
where Tx(ij) is the total cross traffic between Site i and Site j, Tij is the value in cell ij of data matrix, and Tji is the value in cell ji of data matrix.

A stage 354 determines the relative thickness of connectors (such as connecting lines) between circles, for example, by normalizing to the thickest connector. In an embodiment of the present invention, the following may be utilized to perform the stage 354:
Define Lmax=Rmax/2 and Lij=[Tx(ij)/Tx(ij)max]*Lmax,
where Lij is thickness of line connecting circles i and j, Lmax is the maximum thickness (e.g., chosen to fit the chart to a given page or display size), Rmax is the maximum radius, and Tx(ij) is the total cross traffic between Site i and Site j (such as discussed with reference to the stage 352).

A stage 356 connects the circles with the corresponding connectors (e.g., those determined by the stage 354). A stage 358 provides a directional indicator or net flow indicator (e.g., an arrow or series of arrows such as 212 of FIG. 2) along each connector (e.g., in the middle). In an embodiment of the present invention, the net flow indicating the direction of the indicator may be calculated as follows:
if Tba>Tab, then arrow points from circle B to circle A (where Tba is the traffic from B to A and Tab is the traffic from A to B);
if Tba<Tab, then arrow points from circle A to circle B; and
If Tba=Tab, then plot no arrow (or other indicator such as dashes).

This technique may then be applied for each pair of sites to determine the directional indicator of the stage 358. A stage 360 resizes the chart to fit a given page and/or display. In a stage 362, outflow indicators are provided from each site (such as 218 and 220 of FIG. 2). As illustrated in FIG. 2, the outflow indicators may include actual values for the respective traffic. The method 350 ends after a stage 364 in which a label and total traffic values for each site are provided. In one embodiment of the present invention, these items may be provided inside each circle.

In yet a further embodiment of the present invention, the techniques discussed herein are envisioned to represent the interaction of modules within a given web site, rather than web traffic between sites such as those discussed with respect to sites 202, 204, 206, 208, and 210 of FIG. 2. The site modules may be any reservoir such as a subsection of the site, a directory, a subdirectory, predefined content group, and the like.

In an embodiment of the present invention, for interaction between separate sites, the following reports may be run:
(1) “Top Referring Web Sites” to site of interest A, over the time period of interest, measured by “visits”, with optional filter(s) limiting the data to additional conditions of interest (such as looking at referrals only from first time users, or maybe only from repeat users, or maybe only from users who browsed more than one page on your site);
(2) “Visits over time” to site of interest A, summed over the time period of interest, measured by “visits”, with optional filter(s) limiting the data to additional conditions of interest (such as looking at traffic only from first time users, or maybe only from repeat users, or maybe only from users who browsed more than one page on your site); and
(3) run both 1 and 2 again for each web site (B-N) in the system being charted.

In another embodiment of the present invention, for interaction between subsections of a site, the following reports may be run:
(1) “Top Internal Referrers” to subsection of interest A over the time period of interest, measured by “page views”, with optional filter(s) limiting the data to additional conditions of interest (such as looking at page views only from first time users, or maybe only from repeat users, or maybe only from users who browsed more than one page on your site);
(2) “Page views over time” to subsection of interest A, summed over the time period of interest, measured by “page views”, with optional filter(s) limiting the data to additional conditions of interest (such as looking at traffic only from first time users, or maybe only from repeat users, or maybe only from users who browsed more than one page on your site);
(3) run both 1 and 2 again for each subsection (B-N) in the system being charted.

In a further embodiment of the present invention, the difference between building this chart for sites, as compared to subsections of sites, is that traffic between sites is generally measured using the “visits” metric, while traffic within a site is more often measured by the “page view” metric.

The foregoing description has been directed to specific embodiments. It will be apparent to those with ordinary skill in the art that modifications may be made to the described embodiments, with the attainment of all or some of the advantages. For example, the techniques of the present invention may be applied to air traffic (e.g., between airports, runways, and the like), shoppers between stores, water flow, electricity flow, oil and gas flow, cash flow (e.g., between banks), highway traffic, and the like. Therefore, it is the object of the appended claims to cover all such variations and modifications as come within the spirit and scope of the invention.

1. A graphical representation of interaction between reservoirs comprising:
a plurality of reservoirs, each of the plurality reservoirs communicating with at least another one of the plurality of reservoirs;
a plurality of connectors disposed between select reservoirs from the plurality of reservoirs to indicate communication between the select reservoirs of the plurality of reservoirs, each of the connectors having a prominence corresponding to a level of the communication between the select reservoirs;
a plurality of net flow indicators to identify a net flow between the select reservoirs of the plurality of reservoirs; and
a plurality of outflow indicators to indicate an amount of traffic between the select reservoirs of the plurality of reservoirs.

2. The graphical representation of claim 1 wherein the plurality of reservoirs are selected from a group comprising web sites, subsections of a web site, directories, subdirectories, stores, airports, runways, banks, highways, and predefined content groups.

3. The graphical representation of claim 1 wherein the plurality of connectors are selected from a group comprising solid lines, dotted lines, and combinations thereof.

4. The graphical representation of claim 1 wherein the plurality of net flow indicators are arrows.

5. The graphical representation of claim 4 wherein the arrows are one or more of shaded and colored arrows.

6. The graphical representation of claim 1 wherein the prominence is illustrated by an item selected from a group comprising thickness, color, shapes, and combinations thereof.

7. The graphical representation of claim 1 wherein the level of communication is determined by a total amount of traffic between corresponding reservoirs.

8. The graphical representation of claim 1 wherein each of the plurality of reservoirs is sized based on a total traffic handled by that reservoir.

9. The graphical representation of claim 1 wherein each of the plurality of reservoirs has a different color or shape to identify whether that reservoir is one of an importer reservoir, exporter reservoir, and neutral reservoir.

10. The graphical representation of claim 1 wherein each of the plurality of outflow indicators includes a directional indicator and a value indicator, wherein the value indicator identifies a level of traffic in a single direction.

11. A method of generating a graphical representation of interaction between a plurality of reservoirs comprising:
determining a number of referrals to each of the plurality of reservoirs from the remaining plurality of reservoirs;
determining a total traffic handled by each of the plurality of reservoirs;
determining reservoir types and representing each of the plurality of the reservoirs accordingly;
determining a relative size of each of plurality of reservoirs;
connecting select reservoirs from the plurality of reservoirs;
providing a plurality of net flow indicators between the select reservoirs; and
providing a plurality of outflow indicators between the select reservoirs.

12. The method of claim 11 wherein the reservoir types are selected from a group comprising importer, exporter, and neutral.

13. The method of claim 11 wherein the select reservoirs are connected with a plurality of connectors having a relative prominence corresponding to an amount of traffic between each pair of the select reservoirs.

14. The method of claim 13 wherein the relative prominence is illustrated by an item selected from a group comprising thickness, color, shapes, and combinations thereof.

15. The method of claim 13 wherein the plurality of connectors are selected from a group comprising solid lines, dotted lines, and combinations thereof.

16. The method of claim 11 wherein the relative size of each of the plurality of reservoirs is determined based on the total traffic handled by that reservoir.

17. The method of claim 11 wherein the select reservoirs communicate with each other.

18. The method of claim 11 wherein the plurality of reservoirs are selected from a group comprising web sites, subsections of a web site, directories, subdirectories, stores, airports, runways, banks, highways, and predefined content groups.

19. The method of claim 11 wherein the plurality of net flow indicators are arrows.

20. The method of claim 11 wherein each of the plurality of outflow indicators includes a directional indicator and a value indicator, wherein the value indicator identifies a level of traffic in a single direction.

21. A method of generating a graphical representation of interaction between reservoirs comprising:
providing a plurality of reservoirs, each of the plurality reservoirs communicating with at least another one of the plurality of reservoirs;
providing a plurality of connectors disposed between select reservoirs from the plurality of reservoirs to indicate communication between the select reservoirs of the plurality of reservoirs, each of the connectors having a prominence corresponding to a level of the communication between the select reservoirs;
providing a plurality of net flow indicators to identify a net flow between the select reservoirs of the plurality of reservoirs; and
providing a plurality of outflow indicators to indicate an amount of traffic between the select reservoirs of the plurality of reservoirs.

22. The method of claim 21 wherein the plurality of reservoirs are selected from a group comprising web sites, subsections of a web site, directories, subdirectories, stores, airports, runways, banks, highways, and predefined content groups.

23. The method of claim 21 wherein the plurality of connectors are selected from a group comprising solid lines, dotted lines, and combinations thereof.

24. The method of claim 21 wherein the plurality of net flow indicators are arrows.

25. The method of claim 21 wherein the arrows are one or more of shaded and colored arrows.

26. The method of claim 21 wherein the prominence is illustrated by an item selected from a group comprising thickness, color, shapes, and combinations thereof.

27. The method of claim 21 wherein the level of communication is determined by a total amount of traffic between corresponding reservoirs.

28. The method of claim 21 wherein each of the plurality of reservoirs is sized based on a total traffic handled by that reservoir.

29. The method of claim 21 wherein each of the plurality of reservoirs has a different color or shape to identify whether that reservoir is one of an importer reservoir, exporter reservoir, and neutral reservoir.

30. The method of claim 21 wherein each of the plurality of outflow indicators includes a directional indicator and a value indicator, wherein the value indicator identifies a level of traffic in a single direction.

31. An article of manufacture comprising:
a machine readable medium that provides instructions that, if executed by a machine, will cause the machine to perform operations including:
providing a plurality of reservoirs, each of the plurality reservoirs communicating with at least another one of the plurality of reservoirs;
providing a plurality of connectors disposed between select reservoirs from the plurality of reservoirs to indicate communication between the select reservoirs of the plurality of reservoirs, each of the connectors having a prominence corresponding to a level of the communication between the select reservoirs;
providing a plurality of net flow indicators to identify a net flow between the select reservoirs of the plurality of reservoirs; and
providing a plurality of outflow indicators to indicate an amount of traffic between the select reservoirs of the plurality of reservoirs.

32. The article of claim 31 wherein the plurality of reservoirs are selected from a group comprising web sites, subsections of a web site, directories, subdirectories, stores, airports, runways, banks, highways, and predefined content groups.

33. The article of claim 31 wherein the prominence is illustrated by an item selected from a group comprising thickness, color, shapes, and combinations thereof.

34. A computer system comprising:
a central processing unit (CPU);
a storage device coupled to the CPU to store:
a machine readable medium that provides instructions that, if executed by a machine, will cause the machine to perform operations including:
providing a plurality of reservoirs, each of the plurality reservoirs communicating with at least another one of the plurality of reservoirs;
providing a plurality of connectors disposed between select reservoirs from the plurality of reservoirs to indicate communication between the select reservoirs of the plurality of reservoirs, each of the connectors having a prominence corresponding to a level of the communication between the select reservoirs;
providing a plurality of net flow indicators to identify a net flow between the select reservoirs of the plurality of reservoirs; and
providing a plurality of outflow indicators to indicate an amount of traffic between the select reservoirs of the plurality of reservoirs.

35. The computer system of claim 34 wherein the storage device is selected from a group comprising floppy diskette, hard disk, optical disk, compact disc-read only memory (CD-ROM), magneto-optical disk, read-only memory (ROM), random-access memory (RAM), erasable programmable ROM (EPROM), electrically EPROM (EEPROM), magnetic or optical card, and flash memory.

36. The computer system of claim 34 wherein the CPU is selected from a group comprising a complex instruction set computer (CISC) microprocessor, a reduced instruction set computing (RISC) microprocessor, a very long instruction word (VLIW) microprocessor, and a processor implementing a combination of instruction sets.
